(19) United States
(12) Patent Application Publication
(10) Pub. No.: US 2012/0156375 A1
(43) Pub. Date: Jun. 21, 2012

(54) INKJET INK COMPOSITION WITH JETTING AID

(76) Inventors: Thomas B. Brust, Webster, NY (US); Kurt Michael Schroeder, Spencerport, NY (US); Paul Matthew Hoderlein, Rochester, NY (US)

(21) Appl. No.: 12/972,581

(22) Filed: Dec. 20, 2010

(51) Int. Cl. C09D 11/10; B05D 5/00

(52) U.S. Cl. 427/256; 524/556; 524/496

(57) ABSTRACT

An inkjet ink composition comprising water, self-dispersing carbon black pigment particles, and a copolymer jetting aid; wherein the copolymer jetting aid comprises a copolymer obtained from polymerizing at least 5 weight percent of one or more monomers comprising a long hydrocarbon chain having greater than or equal to 12 carbons and from 5 to 30 weight percent of one or more acidic monomers. The inks of the present invention have improved stable drop velocities over extended droplet ejection events.

### FIELD OF THE INVENTION

The present invention relates to an inkjet ink composition and method of printing employing an ink containing water, carbon black self-dispersed pigment, and particular polymeric jetting aid component.

### BACKGROUND OF THE INVENTION

Inkjet printing is a non-impact method for producing printed images by the deposition of ink droplets in a pixel-by-pixel manner to an image-recording element in response to digital data signals. There are various methods that may be utilized to control the deposition of ink droplets on the image-recording element to yield the desired printed image. In one process, known as drop-on-demand inkjet, individual ink droplets are projected as needed onto the image-recording element to form the desired printed image. Common methods of controlling the projection of ink droplets in drop-on-demand printing include piezoelectric transducers and thermal bubble formation. In another process, known as continuous inkjet, a continuous stream of droplets is charged and deflected in an image-wise manner onto the surface of the image-recording element, while un-imaged droplets are caught and returned to an ink sump. Inkjet printers have found broad applications across markets ranging from desktop document and photographic-quality imaging, to short run printing and industrial labeling.

The inks used in the various inkjet printers can be classified as either dye-based or pigment-based. A dye is a colorant that is dissolved in the carrier medium. A pigment is a colorant that is insoluble in the carrier medium, but is dispersed or suspended in the form of small particles. These small particles can be stabilized against flocculation and settling by the use of distinct dispersing agents such as surfactants, oligomers or polymers, or they can be directly functionalized to provide a self-dispersing characteristic. In either case the carrier medium can be a liquid or a solid at room temperature. Commonly used carrier media include water, mixtures of water and organic co-solvents and high boiling organic solvents, such as hydrocarbons, esters, ketones, alcohols and ethers.

Pigment-based inkjet inks are often preferred over dye-based inkjet inks because of the superior image stability typically observed with the pigment-based inks. Self-dispersed pigments in turn are often preferred over surfactant-dispersed, oligomer-dispersed or polymer-dispersed pigments because of their greater stability to a variety of ink formulations and environmental keeping conditions. Self-dispersed pigments are typically used when high density and sharp images are required such as for the printing of text and graphics, and are especially useful when printing on plain papers (ie. papers not specifically designed to render photographic quality images).

Self-dispersed pigments useful for inkjet printing have been prepared by a number of different processes. U.S. Pat. Nos. 5,554,739; 5,803,959; and 5,922,118 disclose covalent functionalization of pigment surfaces using diazonium compounds. U.S. Pat. Nos. 5,609,671; 5,718,746; 6,099,632; and 7,232,480 describe anionic self-dispersed pigments prepared by a hypochlorite oxidation process. U.S. Pat. No. 6,852,156 describes anionic pigments prepared by ozone oxidation.

Among the different types of self-dispersed pigments, those having a high degree of surface functionalization provide advantages in the printing of inkjet images. US Patent Publication No. 2007/0028800 discloses self-dispersed pigments having a charge equivalence of at least 0.5 mEq/g that have been carboxylate functionalized. U.S. Pat. No. 5,861,447 and US Patent Publication No. 2008/0206465 disclose self-dispersed pigments having greater than 11 weight % volatile surface functional groups.

Key attributes for inkjet printing on plain papers include high print density, sharp text quality, and high print durability such as high resistance to water, rub and highlighter smear for the printed document on plain paper. Equally important is printing quality uniformity across a large variety of plain papers. The performance of inkjet printing on plain paper is very sensitive to paper type. Paper type in turn is affected by the paper formulation (e.g. size agent type and amount, filler type and amount, etc.), the manufacturing process, and paper pulp variation. It is highly desirable to have ink formulations that can provide excellent and uniform print quality with low paper-to-paper variability. In addition, jetting performance of the ink is equally important. This includes, for example, forming stable drops, robust jetting at the desired firing frequency, and maintaining the jetting performance, e.g. constant drop velocity during the extended printhead life cycle. Although self-dispersed pigments have a number of advantages when used in inkjet inks, they also present disadvantages. For example, self-dispersed pigment inks are particularly susceptible to smearing, especially with respect to high-lighter markers used in the marking of text images. Thus, inks containing self-dispersed pigments have to date failed to provide all the desired attributes of an ink-jet ink intended for use on plain papers.

Various improvements have been proposed by workers in the field. It is known in the art of self-dispersed pigment inks, e.g., to add water-soluble polymers, neutralized with organic or inorganic bases, to improve the smear resistance of the printed images. U.S. Pat. No. 5,846,307 and JP Publication No. 2003-171590 both describe an ink containing a self-dispersed carbon black with an organic base neutralized water soluble polymer. However, due to the interaction with printhead materials such as the heater surface in a thermal inkjet printer, such polymers may cause severe degradation in jetting performance. U.S. Pat. Nos. 5,571,311 and 6,329,446 and US Publication No. 2005/0020730 all describe an ink containing a self-dispersed carbon black and a water soluble polymer. However, the self-dispersed carbon black dispersion comprises low level of volatile surface functional groups, which leads to undesirable plain paper performance such as high paper-to-paper variability. U.S. Pat. No. 6,866,379 discloses use of water soluble polymers having acid groups neutralized by an alkali metal hydroxide in pigment-based inkjet inks results in improved physical durability such as scratch and smudging resistance while maintaining reliable jetting from inkjet printheads. The presence of significant amounts of polymers in a self-dispersed pigment ink, however, can reduce the amount of achievable density in the printed image. It has been found, however, that addition of water soluble polymers to inkjet inks comprising some self-dispersing carbon black pigments results in an undesirable reduction in print density.

US Publication Numbers 2008/0206465 and 2010/0092669 disclose water soluble polymer addenda that improve the jetting characteristics of self-dispersed carbon black pigment inks. The specific polymer addenda exemplified in these publications, however, are acrylic copolymers of benzylmethacrylate and methacrylic acid and while useful, these copolymers have limited ability to provide inks containing self-dispersing pigments that result in stable velocities during long term jetting over the useful lifetime of an inkjet printhead. US 2010/0092669 discloses the use of organic base in inks thereof to reduce polymer deposits on components of the printing system during periods of latency.

US Publication Numbers 2007/0043144 and 2007/0043146 disclose inkjet ink compositions comprising pigments dispersed with a polymeric dispersant wherein the polymeric dispersant comprises a copolymer comprising hydrophobic methacrylate or acrylate monomer containing an aliphatic chain having at least 12 carbons and a hydrophilic methacrylic or acrylic acid monomer. Use of such polymeric dispersants with limited percentage of acid monomer in inks comprising self-dispersed pigments is not disclosed.

There is a need to provide a pigmented ink composition comprising self-dispersing carbon black pigments which can provide stable droplet velocities over the useful lifetime of an inkjet printhead. More specifically, there is a need to provide pigmented ink compositions that can maintain relatively constant drop velocities in excess of 2×10⁷ droplet ejections and approaching in excess of 5×10⁷ firing events. In addition, inks showing stable droplet velocity desirably must not degrade image quality performance such as high density on plain papers.

### SUMMARY OF THE INVENTION

In accordance with a first embodiment, the invention is directed towards an inkjet ink composition comprising water, self-dispersing carbon black pigment particles, and a copolymer jetting aid; wherein the copolymer jetting aid comprises a copolymer obtained from polymerizing at least 5 weight percent of one or more monomers comprising a long hydrocarbon chain having greater than or equal to 12 carbons and from 5 to 30 weight percent of one or more acidic monomers. The inks of the present invention have improved stable drop velocities over extended droplet ejection events.

### DETAILED DESCRIPTION OF THE INVENTION

A self-dispersing pigment is defined as a pigment that retains a state stably dispersed in a liquid carrier medium, such as water, a water-soluble organic solvent or a liquid mixture thereof without requiring use of any dispersing agent such as a water-soluble polymeric compound. It further does not generate aggregates among pigment particles which may interfere with normal ink ejection from orifices using an ink-jet printing technique. In general, there exists two classes of self-dispersing pigments. The first class has a charged (also called hydrophilic) group being bonded directly to the surface of the pigment, and the second class has a charged group being bonded through a linking group to the surface of the pigment.

The first class of self-dispersed pigment is preferably, for example, a pigment in which at least one charged group, such as anionic group, has been bonded directly to the surface of the pigment. Preparation of such pigments is well known in the art. Karl, et al., in U.S. Pat. No. 6,503,311 and Yeh et al., in U.S. Pat. No. 6,852,156, have described anionic self-dispersed pigments prepared by ozone oxidation. Ito et al., in U.S. Pat. No. 6,488,753 and Momose et al., in EP Publication No. 1,479,732 A1, describe anionic self-dispersed pigments prepared by hypochlorite oxidation. Related disclosures occur in U.S. Pat. Nos. 5,609,671; 5,846,307; 5,861,447; 6,099,632; and 6,468,342. Additional peroxo acid oxidations methods are disclosed in JP Publication Numbers 2004-107513, 2004-224955; and 2003-183541. Papirer et al., Carbon, Vol. 34, No. 12, pages 1521 to 1529 (1996) discloses and reviews several additional methods of direct functionalization of carbon surfaces. When applied to pigments, these procedures introduce surface bound hydrophilic or charged groups on the pigment to form self-dispersing pigments comprising a hydrophilic group bonded directly to the surface thereof that are suitable for use in an inkjet ink.

More specifically, this surface-modified carbon black may be prepared by creating a functional group directly on the surface of the carbon black by physical treatment, such as vacuum plasma, or chemical treatment (for example, oxidation with hypochlorous acid, sulfonic acid or the like). According to the present invention, the surface-modified pigment is preferably one produced by a method involving wet oxidation with a hypohalous acid or a salt thereof. Hypohalous acids or salts thereof include sodium hypochlorite, potassium hypochlorite, sodium hypobromite, and potassium hypobromite. Among them, sodium hypochlorite is particularly preferred from the viewpoints of reactivity and cost. Specifically, the method involving wet oxidation with a hypohalous acid or a salt thereof may be carried out as follows.

A pigment and a surface modifier (for example, sodium hypochlorite) are heated and dispersed or stirred in a suitable amount of water. For example, a ball mill, an attritor, a colloid mill, or a sand mill with glass, zirconia, alumina, stainless steel, magnetic or other beads added thereto may be used for stirring. In this case, preferably, the pigment may be previously ground to a desired particle size. Alternatively, the pigment may be reacted with the surface modifier while grinding the pigment. The grinding may be carried out by means of a rotary homogenizer or an ultrasonic homogenizer. Beads and coarse particles are separated from the dispersion after stirring and oxidation, followed by the removal of by-products of the oxidizing agent to perform purification. Thus, an aqueous pigment dispersion is obtained. If necessary, for example, concentration by a separation membrane or the like, filtration through a metallic filter or a membrane filter, classification by centrifugation, or neutralization with a hydroxide of an alkali metal salt or an amine may be carried out. A modified carbon black produced by the hypohalous oxidation method generally as described by Ito et al., in U.S. Pat. No. 6,488,753 and related publications has a high surface carboxylic acid content. As a result, the dispersibility of the modified carbon black in water is very high. Commercially available products may be used as the above pigment, and preferred examples thereof include BONJETt CW-I, BONJET CW-2 and BONJET CW-3 manufactured by Orient Chemical Industries, Ltd, SENSIJET SDP-1000, SENSIJET SDP-2000 and SENSIJET SDP-100 manufactured by Sensient Technologies, and AQUABLACK 162 and AQUABLACK 164 manufactured by Tokai Carbon Co.

The second class of self-dispersed pigment is a pigment in which at least one hydrophilic group, such as an anionic group or cationic group, has been bonded through a linking group to the pigment surface. Generally, a chemical modification is commonly applied in the process. Bergemann, et al., in U.S. Pat. No. 6,758,891 describe the covalent functionalization of pigments by reaction with organic triazoles. Bergemann, et al., in U.S. Pat. No. 6,660,075 further describe the covalent functionalization of pigments by reaction with unsaturated organic compounds. Belmont in U.S. Pat. No. 5,554,739, Adams and Belmont in U.S. Pat. No. 5,707,432, Johnson and Belmont in U.S. Pat. Nos. 5,803,959 and 5,922,118, and in published applications WO 96/18695, WO 96/18696, WO 96/18689, WO 99/51690, WO 00/05313, and WO 01/51566 describe the covalent functionalization of pigments with diazonium compounds. Like preparations of covalently functionalized self-dispersed pigments are additionally described by Osumi et al., in U.S. Pat. No. 6,280,513 and U.S. Pat. No. 6,506,239. Karl et al in U.S. Pat. No. 6,780,389 describe related diazonium induced surface attachment preparations. These publications further describe the preparation and use of inkjet inks employing the described self-dispersed pigments. Both anionic and cationic self-dispersed pigments are described. Papirer et al., Carbon, Vol. 34, No. 12, pages 1521 to 1529 (1996) discloses and reviews several additional methods of direct functionalization of carbon surfaces. When applied to pigments, these procedures introduce hydrophilic or charged groups on the pigment to form a self-dispersed pigment comprising a hydrophilic or charged group bonded through a linking group to the surface thereof suitable for use in inkjet ink. Preferred linking groups are optionally substituted aliphatic groups having 2 to 8 carbon atoms and optionally substituted aromatic groups having 6 to 14 carbon atoms.

Phenyl groups are particularly useful as linking groups. Preferred anionic charged groups are chosen from the group consisting of carboxylic, phosphoric, boronic and sulfonic acid groups. Preferred cationic charged groups are chosen from the group consisting of optionally substituted ammonium and phosphonium groups.

One preferred method is treatment of, for example, a carbon black pigment with aryl diazonium salts containing at least one acidic functional group. Examples of aryl diazonium salts include those prepared from sulfanilic acid, 4-aminobenzoic acid, 4-aminosalicylic acid, 7-amino-4-hydroxy-2-naphthylenesulfonic acid, aminophenyl-boronic acid, aminophenylphosphonic acid, and metalinic acid. Ammonium, quaternary ammonium groups, quaternary phosphonium groups, and protonated amine groups represent examples of cationic groups that can be attached to the same organic groups discussed above. Self-dispersing pigments of this class are also commercially available from Cabot as CAB-O-JET 200 and CAB-O-JET 300. While both anionic and cationic charged self-dispersed pigments are known and can be employed in the practice of the invention, anionic, i.e. negatively charged self-dispersed pigments are preferred.

The following representative water-insoluble pigments are among those useful as substrates suitable for chemical modification as described previously into the pigments in the practice of the invention; however, this listing is not intended to limit the invention. The following representative pigments are available from Cabot: MONARCH 1400, MONARCH 1300, MONARCH 1100, MONARCH 1000, MONARCH 900, MONARCH 880, MONARCH 800, and MONARCH 700. The following representative pigments are available from Ciba-Geigy: IGRALITE RUBINE 4BL. The following representative pigments are available from Columbian: RAVEN 7000, RAVEN 5750, RAVEN 5250, RAVEN 5000, and RAVEN 3500. The following representative pigments are available from Degussa: Color Black FW 200, Color Black FW 2, Color Black FW 2V, Color Black FW 1, Color Black FW 18, Color Black S 160, Color Black S 170, Special Black 6, Special Black 5, Special Black 4A, Special Black 4, PRINTEX U, PRINTEX V, PRINTEX 140U, PRINTEX 140V, NIPex-160, NIPEx-170, and NIPex-180. The following representative pigment is available from DuPont: TIPURE R-101. The following representative pigment is available from Hoechst: PERMANENT RUBINE F6B. The following representative pigment is available from Sun Chemical: LHD9303 Black.

The surface chemistry of the carbon surface after treatment affects its performance on plain paper. All carbon blacks have chemisorbed oxygen complexes (i.e., carboxylic, quinonic, lactonic, or phenolic groups) on their surfaces to varying degrees depending on the surface treatment conditions and mechanism. One way to characterize the amount of the total surface groups as well as the types of the surface groups (i.e., lactonic vs. carboxylic) is through the measurement of volatile surface functional groups. Thermogravimetric analysis (TGA) is used to obtain such information by monitoring the weight change that occurs as the carbon black dispersion sample is being heated.

Specifically, volatile surface functional group and wt % volatile lactonic functional group are obtained following the 5 steps as described below:

Step 1) 95 mls of Reagent grade acetonitrile is added to the 5 mls of carbon black dispersion. This destabilizes the pigment suspension fairly rapidly.

Step 2) Collect the pigment cake by centrifugation at 7500 RPM for 1 hour and place it in a vacuum oven at 80° C. for 16 hours.

Step 3) Place the pigment cake on the sample pan of a standard TGA oven to collect the weight loss using the following scan conditions: 1st temperature range: 25° C. to 700° C., with Nitrogen as the purge gas at a rate of 60 w/min to the TGA oven and 40 cc/min to the TGA balance. The heating rate is 10° C./min.

From the temperature range of 700° C. to 1000° C. switch to air at the same flow rate, with a heating rate of 10° C./min. % of weight loss is recorded during the entire temperature scan range of 25° C. to 1000° C.

Step 4) Calculate the total weight % of volatile surface functional group on the carbon black dispersion surface by the following equation: wt % volatile surface functional group=(weight loss 125° C.→700° C.)/(weight loss 125° C.→700° C.+weight loss 700° C.→805° C.). This is based on the physical understanding during the decomposition of carbon black pigment cake: weight losses before 125° C. are due to the volatile component in the sample; weight losses between 125° C. and 700° C. are associated with surface functional group on the carbon black dispersion particles; weight losses between 700° C. and 805° C. with the air as purge gas is due to the decomposition of carbon black through combustion.

Step 5) Calculate the weight % of lactone functional group on the carbon black dispersion surface using the following equation: wt % volatile lactonic functional group=(weight loss 125° C.→400° C.)/(weight loss 125° C.→700° C.+weight loss 700° C.→805° C.). This is based on the results from pyrolytic gas chromatograph indicating that lactone groups decomposes around 358° C. and carboxyl groups decomposes around 650° C.

The self-dispersing carbon black pigments employed in the present invention preferably have a volatile surface functional group content greater than 11 weight %, more preferably greater than 15%, and most preferably greater than 18%.

The self-dispersing carbon black pigments of the present invention preferably contain anionic groups which are neutralized with an inorganic metal cation selected from sodium, potassium, lithium, and rubidium.

The self-dispersing carbon black pigments of the present invention preferably have a median effective particle diameter from 55 nm to 200 nm, preferably 55 to 170 nm and more preferably 55 to 150 nm. As used herein, median particle diameter refers to the 50th percentile such that 50% of the volume of the particles is composed of particles having diameters smaller than the indicated diameter. It is understood the pigment dispersion of the invention are composed of aggregates of primary carbon black smaller than the mean particle diameter from above. Typical primary particle sizes of the carbon black particles comprising the pigment dispersion may be in the range of 10 nm to 30 nm. The median particle diameter in the present invention is measured by using a Microtrac Ultrafine Particle Analyzer (UPA) 150 from Microtrac, Inc.

The inkjet inks of the present invention may desirably comprise self-dispersing carbon black pigment at a weight concentration of from 1 to 10 wt %, more preferably 3 to 10 wt %.

Inkjet inks of the present invention comprise one or more copolymer jetting aids that improve the long term jetting velocity of the ejected ink droplets from the printhead. The copolymer jetting aids of the invention are prepared by copolymerizing at least one hydrophobic monomer and an acidic monomer. The copolymers used in this invention may be commonly known as water-reducible resins, which are polymers made from monomers having ionizable hydrophilic groups. The polymer is not water-soluble until the ionizable groups are deprotonated by base. The term “water-soluble” is defined herein as when the polymer is dissolved in water and when the polymer is at least partially neutralized with base the resultant solution is visually clear.

The hydrophobic monomer used to prepare the copolymer jetting aid of the present invention is comprised of a long hydrocarbon chain of twelve or more carbon atoms. Particularly useful long chain hydrocarbon groups comprise a carboxylic acid ester-containing functional group. Preferred hydrophobic monomers may be selected from any aliphatic acrylate or methacrylate monomer provided it contains a hydrocarbon chain comprising greater than or equal to 12 carbon atoms. The chains comprising greater than or equal to 12 carbons may be linear or branched. Examples of specific hydrophobic monomers having a long hydrocarbon chain useful in the present invention include one or more of the following: lauryl acrylate, lauryl methacrylate, tridecyl acrylate, tridecyl methacrylate, tetradecyl acrylate, tetradecyl methacrylate, cetyl acrylate, iso-cetyl acrylate, stearyl methacrylate, iso-stearyl methacrylate, stearyl acrylate, stearyl methacrylate, decyltetradecyl acrylate, decyltetradecyl methacrylate, and the like. Preferably the methacrylate or acrylate monomer is stearyl or lauryl methacrylate or acrylate.

The hydrophobic monomer having a carbon chain length of greater than or equal to 12 carbons is preferably present in an amount of from 5-40% by weight of the total copolymer, and more preferably 10-30% by weight. The copolymer may also comprise, in addition to the hydrophobic monomer comprising greater than or equal to 12 carbon chains, other hydrophobic monomers, such as other hydrophobic acrylate or methacrylate monomers, and in a particular embodiment a hydrophobic monomer comprising an aromatic group. For example, the additional aromatic group containing monomer may be benzyl acrylate or benzyl methacrylate. A preferred additional monomer is benzyl methacrylate.

Copolymer jetting aids useful in the present invention are copolymers prepared from at least one acid group containing monomer. A number of useful acid group containing monomers may be used to prepare the copolymer jetting aids including, e.g., maleic acid, fumaric acid, itaconic acid, acrylic acid, methacrylic acid, and the like. Particularly useful acidic monomers include acrylic acid or methacrylic acid, or combinations thereof. Preferably, the acidic monomer is methacrylic acid. The acidic monomer is present in the copolymer in an amount of from 5 to 30 weight percent, preferably 15 to 30% by weight of the monomers that make up the copolymer. Above about 30% acid monomers, the copolymer jetting aids lose their ability to maintain stable jetting velocities. Copolymers having too low wt % acid monomers can be difficult to solubilize into the aqueous phase of the ink composition, and can degrade overall jetting characteristics. Particularly useful copolymer jetting aids comprise between 15% and 27% acid monomers, more preferably between 17% and 25%.

The acid groups on the copolymer jetting aids are preferably neutralized by an inorganic base, preferably an alkaline metal hydroxide, such as potassium hydroxide, sodium hydroxide or lithium hydroxide. The percentage of acid groups on the polymer are neutralized such that, preferably 75% to 100% of the groups are neutralized by alkaline metal hydroxide.

The copolymer jetting aid of the present invention is not limited in the arrangement of the monomers comprising the copolymer. The arrangement of monomers may be totally random, or they may be arranged in blocks such as AB or ABA wherein, A is the hydrophobic monomer and B is the hydrophilic monomer. In addition, the polymer make take the form of a random terpolymer or an ABC triblock wherein, at least one of the A, B, and C blocks is chosen to be the hydrophilic monomer and the remaining blocks are hydrophobic blocks dissimilar from one another. Preferably the copolymer is a random copolymer.

The weight average molecular weight of the copolymer jetting aid of the present invention preferably has an upper limit such that it is less than about 50,000 daltons. Desirably the weight average molecular weight of the copolymer is less than about 25,000 daltons; more preferably it is less than 15,000 and most preferably less than 10,000 daltons. The molecular weight of the copolymer of the present invention has a weight average molecular weight lower limit such that it is greater than about 500 daltons. The molecular weight of the copolymer jetting aid can be controlled by the addition of chain terminating agents such as, for example, thiols. One example of a useful chain terminating agent for the control of molecular weight is dodecanethiol. Copolymers having molecular weights as specified result in inkjet inks having viscosities suitable for ejection from inkjet printheads and in particular thermal droplet ejection printheads.

Copolymer jetting aids for use with self-dispersing pigments in accordance with the present invention may be of the same formulae for the polymeric dispersants disclosed in US Publication Numbers 2007/0043144 and 2007/0043146, the disclosures of which are incorporated by reference herein in their entireties, with the proviso that the acid group containing monomers of such copolymers be limited to from 5 to 30 wt % in accordance with the present invention requirements.

The amount of copolymer jetting aid present in the ink composition of the present invention is preferably from about 0.1% to about 2% by weight based on the total weight of the ink composition. Particularly useful amounts of the copolymer jetting aid are between 0.1% and 1% by weight and more preferably between 0.1% and 0.5% by weight. If the polymer concentration is above 2% by weight in the ink, the density of the printed image may be reduced, and latency of ejected droplets significantly degraded. If the polymer concentration is below 0.1% the ejection firing performance of the ink may be compromised. As the amount of acid monomer is lowered in the total polymer composition, the amount of copolymer jetting aid in the ink composition can be reduced to achieve the desired long term stable jetting velocities. For example, a copolymer having between 17% and 23% acid monomers can be used at the preferred lower concentration of 0.1% in order to achieve stable jetting velocities while a copolymer having greater acid content may require more of the copolymer in the ink composition to achieve the same velocity stabilization. The selection of the amount of acid monomers in the final polymer can be tailored to the type and amounts of the other hydrophobic monomers present in the polymer composition. It is a particular advantage of the invention that the described copolymer jetting aids are effective at maintaining long term jetting velocity performance even when used at the relatively low concentration of 0.1 to 0.5 wt %, particularly when employing relatively high pigment concentrations (e.g., 3 to 10 wt %).

The ink composition may also include, in addition to the specified copolymer jetting aid, other water-soluble polymers that may provide enhanced jetting or print performance to the ink composition. Ink compositions of the present invention may include, e.g., in addition to the specified copolymer jetting aid, other copolymers of hydrophobic monomers and acid monomers having compositions with greater than 30% acid monomers or less than 5% monomers comprising a long hydrocarbon chain having twelve or more carbons. Particularly useful such other copolymers may have compositions resulting from the polymerization of aromatic group containing monomers, such as, benzyl methacrylate or benzyl acrylate and acid monomers, such as, methacrylic acid, or acrylic acid.

Ink compositions of the present invention may also include a styrene-acrylic copolymer comprising a mixture of vinyl or unsaturated monomers, including at least one styrenic monomer and at least one acrylic monomer, at least one of which monomers has an acid or acid-providing group. Such polymers are disclosed in, for example, U.S. Pat. Nos. 4,529,787; 4,358,573; 4,522,992; and 4,546,160.

Preferred polymers include, for example, styrene-acrylic acid, styrene-acrylic acid-alkyl acrylate, styrene-maleic acid, styrene-maleic acid-alkyl acrylate, styrene-methacrylic acid, styrene-methacrylic acid-alkyl acrylate, and styrene-maleic acid half ester, wherein each type of monomer may correspond to one or more particular monomers. Examples of preferred polymers include, but are not limited to, styrene-acrylic acid copolymer, (3-methyl styrene)-acrylic acid copolymer, styrene-methacrylic acid copolymer, styrene-butyl acrylate-acrylic acid terpolymer, styrene-butyl methacrylate-acrylic acid terpolymer, styrene-methyl methacrylate-acrylic acid terpolymer, styrene-butyl acrylate-ethyl acrylate-acrylic acid tetrapolymer, and styrene-(α-methylstyrene)-butyl acrylate-acrylic acid tetrapolymer.

Surfactants may be added to adjust the surface tension of the ink to an appropriate level. The level of surfactants to be used can be determined through simple trial and error experiments, usually 0.01% to 6%, preferably, 0.1% to 2% by weight of the total ink composition. Anionic, cationic, and nonionic surfactants may be selected from those disclosed in U.S. Pat. Nos. 5,324,349; 4,156,616; and 5,279,654 as well as many other surfactants known in the inkjet ink art. Commercial surfactants include the SURFYNOLS from Air Products, the ZONYLS from DuPont, and the FLURADS from 3M. Examples of suitable nonionic surfactants include linear or secondary alcohol ethoxylates (such as the TERGITOL 15-S and TERGITOL TMN series available from Union Carbide and the BRIJ series from Uniquema), ethoxylated alkyl phenols (such as the TRITON series from Union Carbide), fluoro surfactants (such as the ZONYLS from DuPont, and the FLURADS from 3M), fatty acid ethoxylates, fatty amide ethoxylates, ethoxylated and propoxylated block copolymers (such as the PLURONIC and TETRONIC series from BASF), ethoxylated and propoxylated silicone based surfactants (such as the SILWET series from CK Witco), alkyl polyglycosides (such as the GLUCOPONS from Cognis) and acetylenic polyethylene oxide surfactants (such as the SURFYNOLS from Air Products). Examples of anionic surfactants include carboxylated (such as ether carboxylates and sulfosuccinates), sulfated (such as sodium dodecyl sulfate), sulfonated (such as dodecyl benzene sulfonate, alpha olefin sulfonates, alkyl diphenyl oxide disulfonates, fatty acid taurates, and alkyl naphthalene sulfonates), phosphated (such as phosphated esters of alkyl and aryl alcohols, including the STRODEX series from Dexter Chemical), phosphonated and amine oxide surfactants, and anionic fluorinated surfactants. Examples of amphoteric surfactants include betaines, sultaines, and aminopropionates. Examples of cationic surfactants include quaternary ammonium compounds, cationic amine oxides, ethoxylated fatty amines, and imidazoline surfactants. Additional examples of the above surfactants are described in “McCutcheon's Emulsifiers and Detergents,” 1995, North American Editor. Inkjet inks suitable for use with inkjet printing systems and to apply to non-absorbing substrates, especially high surface energy hydrophobic surfaces, should have a surface tension in the range of 20 dynes/cm to 60 dynes/cm and, more preferably, in the range 20 dynes/cm to 50 dynes/cm.

The ink preferably has physical properties compatible with a wide range of ejecting conditions, i.e., driving voltages and pulse widths for thermal inkjet printing devices, driving frequencies of the piezo element for either a drop-on-demand device or a continuous device, and the shape and size of the nozzle. The exact choice of ink components will depend upon the specific application and performance requirements of the printhead from which they are jetted. Thermal and piezoelectric drop-on-demand printheads and continuous printheads each require ink compositions with a different set of physical properties in order to achieve reliable and accurate jetting of the ink, as is well known in the art of inkjet printing. Acceptable viscosities are typically no greater than 20 cP, and preferably in the range of 1.0 to 6.0 cP and most preferably in the range of 1.5 and 3 cP. The inkjet inks useful in the invention typically exhibit a solution density of between 1 and 1.2 g/cc.

A biocide (0.01-1.0% by weight) may also be added to prevent unwanted microbial growth which may occur in the ink over time. Preferred biocides for the inks employed in the present invention are PROXEL GXL (Zeneca Colours Co.) at a concentration of 0.05-0.1% by weight and KORDEK (Rohm and Haas Co.) at a concentration of 0.05-0.1% by weight (based on 100% active ingredient). Additional additives which may optionally be present in an inkjet ink composition include thickeners, conductivity enhancing agents, anti-kogation agents, drying agents, waterfast agents, dye solubilizers, chelating agents, binders, light stabilizers, viscosifiers, buffering agents, anti-mold agents, anti-curl agents, stabilizers, and defoamers.

The pH of the aqueous ink compositions of the invention may be adjusted by the addition of acids or bases. Useful inks may have a preferred pH of from 4 to 10, depending upon the type of pigment being used. Preferably, the pH of the present ink is from 5 to 9, more preferably from 7 to 9. Typical inorganic acids include hydrochloric, phosphoric, and sulfuric acids. Typical organic acids include methanesulfonic, acetic, and lactic acids. Typical inorganic bases include alkali metal hydroxides and carbonates. In a particular embodiment, an organic base may be employed to reduce polymer deposits on components of the printing system during periods of latency as disclosed in US 2010/0092669, the disclosure of which is incorporated by reference herein. Typical organic bases include ammonia, tetramethylethlenediamine, and triethanolamine. Particularly useful organic bases include those having pKa's in the range of between 7 and 9. Preferred organic bases include those selected from imidazole, N,N-Bis(2-hydroxyethyl)taurine, 4-Morpholinepropanesulfonic acid, triethanolamine, tris(hydroxymethyl)aminomethane, tricine, and diglycine.

It is also contemplated that the ink compositions of the present invention may also contain non-colored particles such as inorganic particles or polymeric particles. The use of such particulate addenda has increased over the past several years, especially in inkjet ink compositions intended for photographic-quality imaging. For example, U.S. Pat. No. 5,925,178 describes the use of inorganic particles in pigment-based inks in order to improve optical density and rub resistance of the pigment particles on the image-recording element. In another example, U.S. Pat. No. 6,508,548 describes the use of a water-dispersible polymeric latex in dye-based inks in order to improve light and ozone resistance of the printed images. The ink composition may contain non-colored particles such as inorganic or polymeric particles in order to improve gloss differential, light and/or ozone resistance, waterfastness, rub resistance and various other properties of a printed image; see for example, U.S. Pat. No. 6,598,967 or 6,508,548.

Examples of inorganic particles useful in the invention include, but are not limited to, alumina, boehmite, clay, calcium carbonate, titanium dioxide, calcined clay, aluminosilicates, silica, or barium sulfate. Examples of polymeric particles useful in the invention include water-dispersible polymers generally classified as either addition polymers or condensation polymers, both of which are well-known to those skilled in the art of polymer chemistry. Examples of polymer classes include acrylics, styrenics, polyethylenes, polypropylenes, polyesters, polyamides, polyurethanes, polyureas, polyethers, polycarbonates, polyacid anhydrides, and copolymers consisting of combinations thereof. Such polymer particles can be ionomeric, film-forming, non-film-forming, fusible, or heavily cross-linked and can have a wide range of molecular weights and glass transition temperatures.

Examples of useful polymeric particles are styrene-acrylic copolymers sold under the trade names JONCRYL (S.C. Johnson Co.), UCAR (Dow Chemical Co.), JONREZ (MeadWestvaco Corp.), and VANCRYL (Air Products and Chemicals, Inc.); sulfonated polyesters sold under the trade name EASTMAN AQ (Eastman Chemical Co.); polyethylene or polypropylene resin emulsions and polyurethanes (such as the WITCOBONDS from Witco Corp.). These polymeric particles are preferred because they are compatible in typical aqueous-based ink compositions, and because they render printed images that are highly durable towards physical abrasion, light, and ozone.

The non-colored particles used in the ink composition of the invention may be present in any effective amount, generally from 0.01 to 20% by weight, and preferably from 0.01 to 6% by weight. The exact choice of non-colored particles will depend upon the specific application and performance requirements of the printed image.

Ink compositions useful in the invention may include humectants and/or co-solvents in order to prevent the ink composition from drying out or crusting in the nozzles of the printhead, aid solubility of the components in the ink composition, or facilitate penetration of the ink composition into the image-recording element after printing. Representative examples of humectants and co-solvents used in aqueous-based ink compositions include: (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) polyhydric alcohols, such as ethylene glycol, diethylene glycol, Methylene glycol, tetraethylene glycol, propylene glycol, polyethylene glycol, polypropylene glycol, 1,2-propane dial, 1,3-propane diol, 1,2-butane diol, 1,3-butane diol, 1,4-butane diol, 1,2-pentane diol, 1,5-pentanediol, 1,2-hexanediol, 1,6-hexane diol, 2-methyl-2,4-pentanediol, 1,2-heptane diol, 1,7-hexane diol, 2-ethyl-1,3-hexane diol, 1,2-octane diol, 2,2,4-trimethyl-1,3-pentane diol, 1,8-octane diol, glycerol, 1,2,6-hexanetriol, 2-ethyl-2-hydroxymethyl-propane diol, saccharides and sugar alcohols and thioglycol; (3) lower mono- and di-alkyl ethers derived from the polyhydric alcohols such as, ethylene glycol monomethyl ether, ethylene glycol monobutyl ether, ethylene glycol monoethyl ether acetate, diethylene glycol monomethyl ether, diethylene glycol monobutyl ether, polyethylene glycol monobutyl ether, and diethylene glycol monobutyl ether acetate; (4) nitrogen-containing compounds such as urea, 2-pyrrolidone, N-methyl-2-pyrrolidone, and 1,3-dimethyl-2-imidazolidinone; and (5) sulfur-containing compounds such as 2,2′-thiodiethanol, dimethyl sulfoxide and tetramethylene sulfone. Typical aqueous-based ink compositions useful in the invention may contain, for example, the following components based on the total weight of the ink: water 20-95%, humectant(s) 5-70%, and co-solvent(s) 2-20%.

Inkjet printing systems useful in the invention comprise a printer, at least one ink composition in accordance with the invention, and an image recording element, typically a sheet (herein also “media”), suitable for receiving ink from an inkjet printer. In one embodiment, the invention is directed towards an inkjet printing method comprising the steps of: a) providing an inkjet printer that is responsive to digital data signals; b) loading the printer with an inkjet recording element; c) loading the printer with an aqueous inkjet ink composition of the invention; and d) applying the inkjet ink composition to the inkjet recording element in response to digital data signals. Inkjet printing is a non-impact method for producing printed images by the deposition of ink droplets in a pixel-by-pixel manner to an image-recording element in response to digital data signals. There are various methods that may be utilized to control the deposition of ink droplets on the image-recording element to yield the desired printed image. In one process, known as drop-on-demand inkjet, individual ink droplets are projected as needed onto the image-recording element to form the desired printed image. Common methods of controlling the projection of ink droplets in drop-on-demand printing include piezoelectric transducers and thermal bubble formation. Drop-on-demand (DOD) liquid emission devices have been known as ink printing devices in inkjet printing systems for many years. Early devices were based on piezoelectric actuators such as are disclosed in U.S. Pat. Nos. 3,946,398 and 3,747,120. A currently popular form of inkjet printing, thermal inkjet (or “thermal bubble jet”), uses electrically resistive heaters to generate vapor bubbles which cause drop emission, as is discussed in U.S. Pat. No. 4,296,421. In another process, known as continuous inkjet, a continuous stream of droplets is charged and deflected in an image-wise manner onto the surface of the image-recording element, while un-imaged droplets are caught and returned to an ink sump. Continuous inkjet printers are disclosed, e.g., in U.S. Pat. Nos. 6,588,888; 6,554,410; 6,682,182; 6,793,328; 6,866,370; 6,575,566; and 6,517,197. Inkjet printers have found broad applications across markets ranging from desktop document and photographic-quality imaging, to short run printing and industrial labeling. Inket printing methods, and related printers, are commercially available and need not be described in detail.

In one embodiment, the inks of the current invention are preferably utilized in a thermal inkjet printer. During printing in a thermal inkjet printhead, the surface of the bubble-nucleating heater typically reaches about 300 degrees Centigrade and components of the ink can become adhered to the heater surface. Such an accumulated ink residue is sometimes called kogation. Kogation can interfere with the efficient transfer of heat from the heater to the ink for nucleating the vapor bubble that expands to eject a droplet of ink during printing. In some drop ejector designs, subsequent collapse of the vapor bubble onto the heater surface helps to remove kogation or keep it from accumulating. However, in other drop ejector designs or heater firing methods, the bubble may escape through the inkjet printer nozzle, or bubble formation may be otherwise controlled such that it does not collapse on the heater surface in such a way to aggressively clean the heater surface. Such drop ejector designs or heater firing methods can improve long-term heater reliability by reducing the amount of heater damage that can otherwise occur after millions of cycles of bubble collapse. U.S. Pat. Nos. 7,210,766 and 6,443,564, e.g., disclose drop ejectors designed to reduce the intensity of bubble collapse or move its location off the heater surface, and U.S. Pat. No. 6,126,260 discloses use of heater pulsing to form a second bubble to protect the heater from the shock of the collapse of the bubble that fires the jet. For such drop ejector designs or heater firing methods where the bubble escapes through the nozzle or otherwise does not collapse aggressively to help to clean the heater surface, use of a jetting aid added to the ink can be particularly advantageous for keeping the heater surface clean. Even for drop ejector designs and heater firing methods where bubble collapse mechanically breaks up kogation on the heater surface, if the removal is incomplete so that the heater surface is left roughened, the jetting of droplets can still be adversely affected, as indicated by U.S. Pat. No. 6,616,273. Therefore, jetting aids can be beneficial even for such drop ejector designs and heater firing methods.

The inks of the invention are preferably utilized in an inkjet set comprising at least magenta, cyan, yellow, and black inks. Colorless ink compositions that contain non-colored particles and no colorant may also be used.

Colorless ink compositions are often used in the art as “fixers” or insolubilizing fluids that are printed under, over, or with colored ink compositions in order to reduce bleed between colors and waterfastness on plain paper; see for example, U.S. Pat. No. 5,866,638 or 6,450,632. Colorless inks are also used to provide an overcoat to a printed image, usually in order to improve scratch resistance and waterfastness; see for example, US Publication No. 2002/0009547 or EP Publication No. 1,022,151 A1.

Colorless inks are also used to reduce gloss differential in a printed image; see for example, U.S. Pat. No. 6,604,819; US Publication Numbers 2003/0085974, 2003/0193553, and 2003/0189626. In a particular embodiment, the self-dispersing carbon black pigment ink of the invention may be employed in an ink set further comprising pigment-based cyan, magenta, and yellow inks and a colorless protective ink, wherein the relative dynamic and static surface tensions of various pigment based inks and colorless protective ink of the ink set are controlled to control intercolor bleed between the inks as described in US Publication No. 2008/0207805. Pigment-based inks employed in such an ink set may further advantageously comprise water-soluble acrylic type polymeric additives and water dispersible polycarbonate-type or polyether-type polyurethanes as described in US Publication Numbers 2008/0207820 and 2008/0207811.

The process of the present invention can be employed with a wide variety of recording media, including plain papers such as XEROX 4024 papers, including Ashdown 4024 DP, Cortland 4024 DP, Champion 4024 DP, XEROX 4024 D.P. green, XEROX 4024 D.P. pink, XEROX 4024 D.P yellow, and the like, XEROX 4200 papers, XEROX 10 series paper, XEROX Imaging Series LX paper, canary ruled paper, ruled notebook paper, bond paper such as Gilbert 25 percent cotton bond paper, Gilbert 100 percent cotton bond paper, and Strathmore bond paper, recycled papers, silica coated papers such as Sharp Company silica coated paper, JUJO paper, Georgia-Pacific inkjet Paper Catalog Number 214305N, KODAK bright white inkjet paper, HEWLETT PACKARD Color inkjet paper, XEROX Extra Bright white inkjet paper, Georgia-Pacific inkjet Paper Catalog Number 999013, STAPLES inkjet paper, International Paper Great White MultiUse 20 Paper, 8) XEROX Premium Multipurpose Paper, HAMMERMILL Copy plus or ForeMP paper, and HEWLETT PACKARD Multipurpose paper, glossy papers, and the like, transparency materials such as XEROX 3R3351 inkjet transparencies, TETRONIX inkjet transparencies, ARKRIGHT inkjet transparencies, HEWLETT-PACKARD inkjet transparencies, and the like, fabrics, textile products, plastics, polymeric films, inorganic substrates such as metals and wood, and the like.

The following examples illustrate, but do not limit, the utility of the present invention.

### Copolymer Preparations

In a 1-liter, three-necked round-bottom flask equipped with a reflux condenser were mixed under nitrogen atmosphere 67 g of benzyl methacrylate (Bz), 33 g of methacrylic acid (MA), 4.6 g of 1-dodecanethiol, and 400 mL of methyl ethyl ketone. The solution was stirred and purged with nitrogen for 20 minutes and heated to 70° C. in a constant temperature bath; 1.5 g. of Azobisisobutyronitrile (AIBN) was added. After 24 hours, the resulting solution was cooled. The resulting polymer solution was mixed with water and potassium hydroxide to achieve 90% acid neutralization. Thereafter the whole mixture was distilled at 50° C. under reduced pressure to remove the organic solvent. The final water-soluble polymer solution had a concentration of ca. 20 wt. % in water and its pH was ca. 8.5.

A similar procedure was used to prepare additional copolymers by varying the weight of acrylic monomers in the synthesis and each was neutralized with potassium hydroxide to 90% of the theoretical acid groups. The resulting copolymer compositions are summarized below.

Benzylmethacrylate (Bz) and Methacrylic acid (MA) in Bz/MA weight proportions: 67/33 and 77/23

Benzylmethacrylate (Bz), Octadecylmethacrylate (Oc) and Methacrylic acid (MA) in Bz/Oc/MA weight proportions: 37/30/33, 40/30/30, 63/10/27, 65/10/25, 55/20/25, 67/10/23, 62/15/23, 70/10/20, 60/20/20, and 73/10117.

A series of black inkjet inks were prepared having the following composition; 4.5% self-dispersing pigment SENSIJET SDP-1000 (Sensient Technologies) (an anionic self-dispersed pigment with a total weight % of volatile surface functional group of 24%, and median particle diameter of 115 nm), 5% glycerol, 15% diethylene glycol, 0.4% ethoxylated nonionic surfactant, 0.40% triethanolamine, 0.02% KORDEK (Rohm and Haas), copolymer(s) as specified in table 1, and the balance high purity water.

The series of black inkjet inks were then filled into text black ink tanks and placed into a printhead designed for a KODAK EASYSHARE Printer. A laboratory jetting apparatus was used to eject droplets from the printhead in order to measure the velocity of the droplets at the start of droplet ejection and after between 2×10⁷ and 5×10⁷ drop ejections. Table 1 shows the drop velocities of the various inks at the initial stage of firing (after approximately 25,000 ejections) and at the end of the firing events. The calculated percent change in velocity between initial and final drop ejections is also provided. It should be understood that a more negative percent change in velocity is an indication of a poorer performing ink. An ideal ink would show zero percent change in velocity from start to finish or a slightly positive percent change in velocity due to the increase in temperature of the printhead with extended firings. A percent change in velocity more negative than about −15% after 5×10⁷ drop ejections would be considered to be undesirable and would likely result in degraded image quality.

Table 1 exemplifies inks and droplet velocity loss stabilizing polymers within the scope of the present invention. Inks of the present invention contain an effective amount of at least one copolymer jetting aid that suppresses velocity loss over the course of extended droplet ejections. The copolymer addenda useful in the present invention requires the presence of long chain hydrocarbon groups and contains at most about 30% by weight of acid group monomers.

Comparative inks 1, 3, 4, and 5 do not contain polymers that enable the suppression of velocity loss to a desired level after extended droplet ejections. Polymers present in Comparative inks 1 and 3 are copolymers formed from benzylmethacrylate and methacrylic acid monomers and do not contain the necessary long hydrocarbon chain groups as required by the inventive polymers. Note that Comparative ink 3 contains a polymer that meets one of the two conditions of the inventive polymer. Namely, BzMA-77/23 contains less than 30% by weight of acid groups, but lacks the long hydrocarbon chain groups.

Polymers present in Comparative inks 4 and 5 are polymeric half-esters of styrene and maleic anhydride monomers and likewise do not contain the necessary long hydrocarbon chain groups as required by the inventive copolymers.

Comparative ink 2 contains a copolymer formed from benzylmethacrylate, octadecylmethacrylate and methacrylic acid and therefore contains long hydrocarbon chain groups. However, the copolymer has a methacrylic acid content of 33% by weight and thus does not meet the second condition of at most 30% acid groups necessary to achieve the desired suppression of velocity loss after extended droplet ejections.

Inventive inks 1 through 5 exemplify polymers that singularly achieve excellent velocity loss suppression without the use of any additional jetting polymers. Copolymers present in inventive inks 1 through 5 at levels of 0.4 weight percent maintain desired droplet velocity at methacrylic acid levels as high as 30% provided that the octadecylmethacrylate component is present in the polymer. Inventive inks 6 through 10 exemplify the efficacy of copolymers of the present invention when used in combination with a polymer that otherwise does not suppress velocity loss on its own. Copolymers used in inventive inks 6 through 10, having methacrylic acid levels between 17% and 23% of the polymer and an octadecylmethacrylate component, are capable of excellent velocity loss suppression at levels as low as 0.1% in the ink composition.

TABLE 1
Inkjet Ink Compositions Comprising Self-dispersing Carbon Black

| | | | Initial Jetting | Jetting Velocity | Percent |
|---|---|---|---|---|---|
| Black Inkjet | Weight %, | Weight %, | Velocity | after 5 × 10⁷ | Velocity |
| Ink | Polymer 1 | Polymer 2 | (m/s) | Firings | Change |
| Comparative 1 | 0.4, BzMA-67/33 | none | 14.9 | 10.9 | −27 |
| Inventive 1 | 0.4, BzOcMA-67/10/23 | none | 14.0 | 14.5 | 4 |
| Inventive 2 | 0.4, BzOcMA-65/10/25 | none | 15.5 | 14.6 | −6 |
| Inventive 3 | 0.4, BzOcMA-55/20/25 | none | 14.6 | 15.4 | 5 |
| Inventive 4 | 0.4, BzOcMA-63/10/27 | none | 15.5 | 13.8 | −11 |
| Inventive 5 | 0.4, BzOcMA-40/30/30 | none | 15.2 | 13.1 | −14 |
| Comparative 2 | 0.4, BzOcMA-37/30/33 | none | 15.1 | 12.1 | −20 |
| Comparative 3 | 0.1, BzMA-77/23 | 0.3, BzMA-67/33 | 15.9 | 11.1 | −30 |
| Inventive 6 | 0.1, BzOcMA-62/15/23 | 0.3, BzMA-67/33 | 14.4 | 12.9 | −10 |
| Inventive 7 | 0.1, BzOcMA-70/10/20 | 0.3, BzMA-67/33 | 13.9 | 14.1 | 1 |
| Inventive 8 | 0.1, BzOcMA-60/20/20 | 0.3, BzMA-67/33 | 14.3 | 14.4 | 1 |
| Inventive 9 | 0.1, BzOcMA-73/10/17 | 0.3, BzMA-67/33 | 12.6 | 12.6 | 0 |
| Inventive 10 | 0.1, BzOcMA-63/20/l7 | 0.3, BzMA-67/33 | 12.8 | 13.3 | 4 |
| Comparative 4 | 0.1% SMA-1440 | 0.3, BzMA-67/33 | 17.3 | 12.3 @ 2 × 10⁷ | −29 |
| Comparative 5 | 0.1% SMA-2625 | 0.3, BzMA-67/33 | 16.7 | 13.5 @ 2 × 10⁷ | −19 |

The invention has been described with reference to a preferred embodiment however it will be appreciated that variations and modifications can be effected by a person of ordinary skill in the art without departing from the scope of the invention.

1. An inkjet ink composition comprising water, self dispersing carbon black pigment particles and at least one copolymer jetting aid, wherein the copolymer jetting aid comprises a copolymer obtained from polymerizing at least 5 weight percent of one or more monomers comprising a long hydrocarbon chain having twelve or more carbons and from 5 to 30 weight percent of one or more acidic monomers.

2. The ink composition of claim 1, wherein the self-dispersing pigment particles have been directly surface oxidized.

3. The ink composition of claim 2, wherein the self-dispersing pigment particles have been oxidized with hypohalites.

4. The ink composition of claim 1, wherein the self-dispersing pigment particles comprise greater than 11 weight % volatile surface functional groups.

5. The ink composition of claim 1, wherein the self-dispersing pigment particles are anionically charged.

6. The ink composition of claim 5, wherein the anionically charged self-dispersing pigment particles are neutralized by sodium, potassium, lithium, or rubidium cation.

7. The ink composition of claim 1, wherein the copolymer jetting aid comprises at least 10 weight percent of one or more monomer units comprising a long hydrocarbon chain having twelve or more carbons and from 15 to 30 weight percent of one or more acidic monomer units.

8. The ink composition of claim 7, wherein the copolymer jetting aid comprises between 15 to 27 weight percent of acidic monomer units.

9. The ink composition of claim 1, wherein the copolymer jetting aid comprises at least 5% by weight of hydrophobic methacrylic or acrylate monomer units containing an aliphatic chain having greater than or equal to 12 carbons and 15-30% by weight of hydrophilic methacrylic or acrylic acid monomer units.

10. The ink composition of claim 9, wherein the copolymer jetting aid comprises 5-40% by weight of a hydrophobic methacrylic or acrylate monomer containing an aliphatic chain having greater than or equal to 12 carbons.

11. The ink composition of claim 10, wherein the copolymer jetting aid additionally comprises hydrophobic monomer units containing an aromatic group.

12. The ink composition of claim 11, wherein the monomer units containing an aromatic group are benzyl methacrylate monomer units.

13. The ink composition of claim 12, wherein the copolymer jetting aid comprises a terpolymer polymerized from benzyl methacrylate, octadecyl methacrylate, and either methacrylic or acrylic acid.

14. The ink composition of claim 1, wherein the copolymer jetting aid is present at between 0.1% and 0.5% by weight.

15. The ink composition of claim 1 wherein the self-dispersing pigment particles have a median effective particle diameter of from about 55 nm to about 200 nm.

16. The ink composition of claim 1, wherein the self-dispersing pigment particles are present at a weight concentration of from 1 to 10 wt %.

17. The ink composition of claim 1, wherein the self-dispersing pigment particles are present at a weight concentration of from 3 to 10 wt %.

18. An inkjet printing method comprising the steps of:
a) providing an inkjet printer that is responsive to digital data signals;
b) loading the printer with an inkjet recording element;
c) loading the printer with an aqueous inkjet ink composition of claim 1; and
d) applying the inkjet ink composition to the inkjet recording element in response to digital data signals.

19. The method of claim 18 wherein the printer is a thermal inkjet printer.

20. An inkjet ink set comprising distinct cyan, magenta, yellow and black inks, wherein at least one ink of the ink set comprises an ink composition of claim 1.
